(19) United States
(12) Patent Application Publication
(10) Pub. No.: US 2021/0310851 A1
(43) Pub. Date: Oct. 7, 2021

(54) ELECTRONIC WEIGHT SENSOR ASSEMBLY

(71) Applicant: Alberto Carballeira, Miami, FL (US)

(72) Inventor: Alberto Carballeira, Miami, FL (US)

(21) Appl. No.: 17/181,360

(22) Filed: Feb. 22, 2021

Related U.S. Application Data
(60) Provisional application No. 63/006,160, filed on Apr. 7, 2020.

(51) Int. Cl. G01G 19/02; G01G 23/37

(52) U.S. Cl. CPC G01G 19/021; G01G 23/37

(57) ABSTRACT

The present invention is directed to an electronic weight sensor assembly and a method of using it with a user platform. The electronic weight sensor assembly may be used to determine the weight of one or more luggage unit(s). The electronic weight sensor assembly according to the present invention comprises a pad, a sensor assembly, an indicator assembly and a processing unit. The sensor assembly comprises at least one electronic weight sensor disposed on the pad. The pad may be provided with a plurality of foldable segments such that the electronic weight sensor assembly may be disposed into and out of a folded position and an expanded position. The method comprises using a user platform with the electronic weight sensor assembly to determine whether an actual travel configuration comports to air carrier requirements.

### FIELD OF INVENTION

The present invention relates to the field of electronic weight sensors for luggage.

### BACKGROUND

Existing scales and other weight measuring devices do not generally provide for an efficient way to display luggage weight information and link it to a travel itinerary, let alone compare it to air carrier requirements to ensure conformance. Standalone mechanical and electronic scales have other drawbacks, including the fact that often times it is difficult to place luggage on top of the measuring surface. Further drawback associated with weight scales and existing pieces of luggage involve the fact that even if both are provided, it is often difficult to visually determine an accurate weight reading. This is especially the case in connection with mechanical scales.

Accordingly, there is a need in the industry for an electronic weight sensor assembly that overcomes the foregoing drawbacks and provides other advantages. A benefit in the industry would be realized by providing an electronic weight sensor assembly with a sensor assembly cooperatively configured with an indicator assembly to ascertain and visually display the weight of a unit(s) of luggage. A further benefit would be realized by providing an electronic weight sensor assembly with a lightweight pad that may be folded into a collapsed position for convenient and easy storage. Yet a further benefit would be provided by providing an electronic weight sensor assembly comprising a solar panel capable of transforming solar energy into electricity for the functioning of an internal battery system and/or of the various operative components electronic weight sensor assembly. An even further benefit would be provided by providing an electronic weight sensor assembly that may be cooperatively configured with a user platform to effectively manage the weight of one or more units of luggage and compare it to air carrier requirements and guidelines to ensure conformance.

### SUMMARY

The present invention is directed to an electronic weight sensor assembly, which is primarily intended to be used in connection with determining the weight of one or more luggage unit(s). The electronic weight sensor assembly according to the present invention comprises a pad, a sensor assembly, and an indicator assembly. The electronic weight sensor assembly may also comprise a processing board or processing unit operatively configured with the sensors to ascertain the weight of the unit of luggage(s). The processing board or unit may also be configured with the display to show a weight reading of the unit of luggage(s). The present invention is also directed to a corresponding method of using the electronic weight sensor assembly to ascertain the weight of a unit of luggage(s) and save time and effort during checking procedures at an airport. The method is also intended to take into account travel restrictions and/or guidelines from air carriers, and to provide convenient and efficient means to ascertain luggage weight to comport with such restrictions and/or requirements.

The pad of the electronic weight sensor assembly may be provided in various dimensions and/or geometrical configurations according to the intended unit(s) of luggage to be weighted. A top surface of the pad should comprise a sufficient dimension to accommodate at least one, and in some embodiments two or more, electronic weight sensors. As an illustrative example, the pad may be provided with various groups of pad segments, at least some of which may be configured and dimensioned such that a corresponding sensor may be disposed on an inside thereof. It is within the scope of the present invention that the various segments of the pad be collectively disposable into a folded position and an expanded position. The folded position or non-operative position is intended to save space and provide for an efficient way of storing the electronic weight sensor assembly during periods of non-operation. Conversely, the electronic weight sensor assembly, and more specifically the various segments of the pad, may be collectively disposable into the expanded or operative position before placing a unit of luggage above the pad to ascertain a weight reading.

The indicator assembly generally comprises a display that is configured to show the weight of the unit of luggage being ascertained. The indicator assembly may also comprise a solar sensor. The weight sensor assembly may comprise powering capabilities, for example, disposed on the pad, which may provide the necessary electricity for the functioning of the various operative components of the electronic weight sensor assembly. For example, the electronic weight sensor assembly may comprise one or more rechargeable battery units or may also comprise a solar sensor. A solar sensor with photovoltaic components may be disposed, for example, on the pad, and may be configured to transform solar energy into electricity to replenish the charge of a battery unit(s), or electricity that may be transmitted directly to the operative components of the electronic weight sensor. The indicator assembly may further comprise a status indicator.

Further features of the present invention comprise providing a tapered configuration of the pad. Such a tapered configuration may at least partially facilitate displacement of a unit of luggage from a floor or other surface to the top surface of the pad. A tapered configuration may be provided around one or more edges of the pad and is intended to provide a smooth transition from a floor or other surface to the top surface of the pad.

Additional features of the present invention comprise providing one or more tracks configured to at least partially facilitate movement of a unit(s) of luggage from a floor or other surface to the top surface of the pad. The tracks may function as a guide to the wheels of a unit of luggage and may comprise an indentation or recessed configuration. The tracks may comprise a variable width and/or length may be provided with a tapered configuration to further facilitate access to the top surface of the pad. The tracks may be adjacently disposed to one or more edges of the pad and/or adjacent to an electronic weight sensor(s).

Even further features of the present invention comprise implementing wireless capabilities configured to transmit weight data associated with one or readings of the innovative electronic weight sensor assembly. For example, weight data may be transmitted directly from the sensor assembly, i.e., via an electronic weight sensor(s), to the indicator assembly, i.e., to the display.

Yet additional features of the present invention comprise implementing a user platform cooperatively configured with the electronic weight sensor to determine whether a travel configuration comports to the luggage requirements and/or guidelines of air carriers. As used herein, a travel configuration refers to the weight and/or number of one or more units of luggage. The user platform may be accessed via a variety of devices, including mobile and/or desktop devices, and via a mobile application, and/or a web browser. It is within the scope of the present invention that weight data may be transmitted from the sensor assembly to the mobile or desktop device, for example via a server, data network, cloud computing, etc. The weight data may be similarly transmitted from the indicator assembly to a mobile or desktop device. The user platform may be accessed by one or more users to capture and/or process weight data associated with one or more actual readings of the innovative weight sensor assembly. Thus, it is within the scope of the present invention that the user platform be continuously updated with information relating with a current and/or actual weigh reading(s) of the innovative weight sensor assembly. A user may take one or more readings on the weight sensor assembly and access the user platform to automatically store and/or record such weight readings. Alternatively, a user may manually input actual weight readings or otherwise data relating to the weight of a unit(s) of luggage. The user platform may then process such acquired and/or inputted weight data and compare it to the air carrier requirements associated with a specific travel itinerary.

Yet additional features of the present invention comprise incorporating real-time aviation information to the user platform. Aviation information may be included in a real-time database that may be accessed via the user platform. Aviation information may comprise commercial airline luggage restrictions, for example, number of allowed luggage units allowed on a given national or international flight, and its weight restrictions for on-board luggage and/or carry-on luggage. If the weight data does not comport to specific travel requirements or guidelines, the user platform may provide a reconfiguration scheme, including which specific units of luggage may need weight adjustments to conform to air carrier requirements.

The present invention is also directed towards a method of using the user platform and the electronic weight sensor assembly to ensure that the weight and number of a unit(s) of luggage associated with a specific travel itinerary conform to specific requirements and guidelines of air carriers. A user may login to the user platform and use the electronic weight sensor assembly to determine the weight of one or more units of luggage in connection with a specific travel itinerary. The user may also manually input weight data associated with the units of luggage, for example, including from a prior reading. The user may further input data relating to a specific travel itinerary. The user platform may be continuously updated with real-time information relating to specific air carrier restrictions and guidelines as to weight and/or number of units of luggage permitted on a given flight(s). The user platform may also determine whether an actual travel configuration comports to such air carrier requirements. If an actual travel configuration does not comport to specific air carrier requirements, the user platform may devise and recommend a reconfiguration scheme.

### BRIEF DESCRIPTION OF THE DRAWINGS

FIG. 1 is a top view of one embodiment of the electronic weight sensor assembly according to the present invention.

FIG. 2 is a top view of another embodiment of the electronic weight sensor assembly according to the present invention comprising tracks disposed on the pad.

FIG. 3 is a side view of yet another embodiment of the electronic weight sensor assembly according to the present invention comprising a tapered configuration on one of the side edges of the pad.

FIG. 4 is a perspective view of one embodiment of the electronic weight sensor assembly according to the present invention disposed in the expanded position.

FIG. 5 is a perspective view of yet another embodiment of the electronic weight sensor assembly according to the present invention.

FIG. 6 is a perspective view of an even further embodiment of the electronic weight sensor assembly according to the present invention.

FIG. 7 is a perspective view of one embodiment of the electronic weight sensor assembly according to the present invention disposed in the expanded position.

FIG. 8 is a diagrammatic representation of the method according to the present invention of using a user platform and an electronic weight sensor assembly to verify the weight of a smart luggage unit(s).

### DETAILED DESCRIPTION

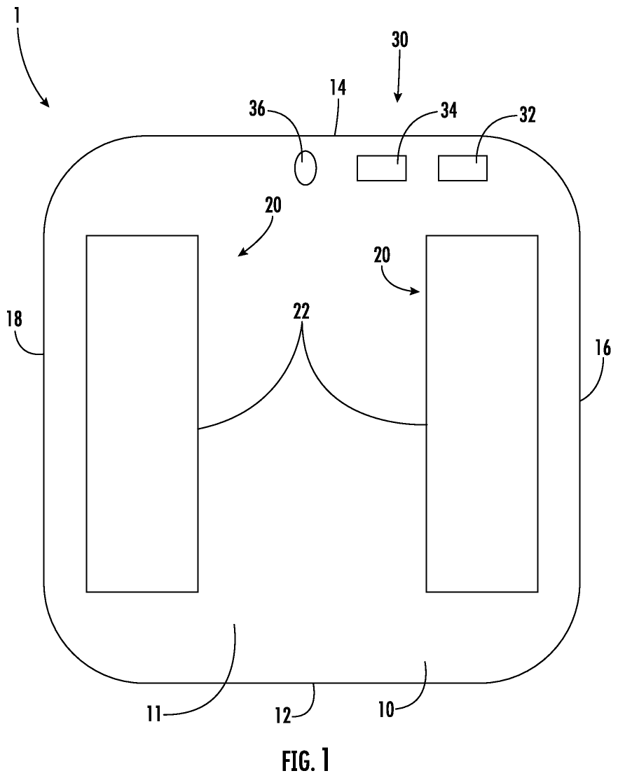

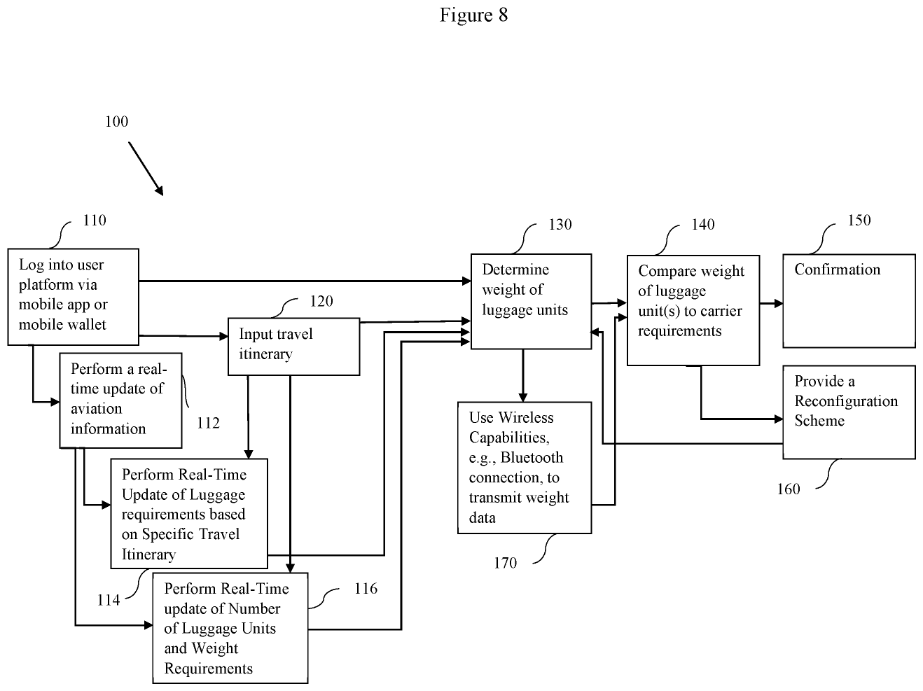

With initial reference to FIGS. 1-7, the present invention is directed to an electronic weight sensor assembly 1. With reference to FIG. 8, the present invention is also directed towards a method 100 of using the electronic weight sensor assembly 1 to ascertain the weight of one or more units of luggage and ensure compliance with air carriers and/or guidelines. The electronic weight sensor assembly 1 assembly is primarily intended to be used in connection with determining the weight of a luggage unit(s), but it may be used to determine the weight of other components or items that may be placed on the electronic weight sensor assembly 1. The electronic weight sensor assembly 1 according to the present invention comprises a pad 10, a sensor assembly 20, an indicator assembly 30 and a processing unit 60.

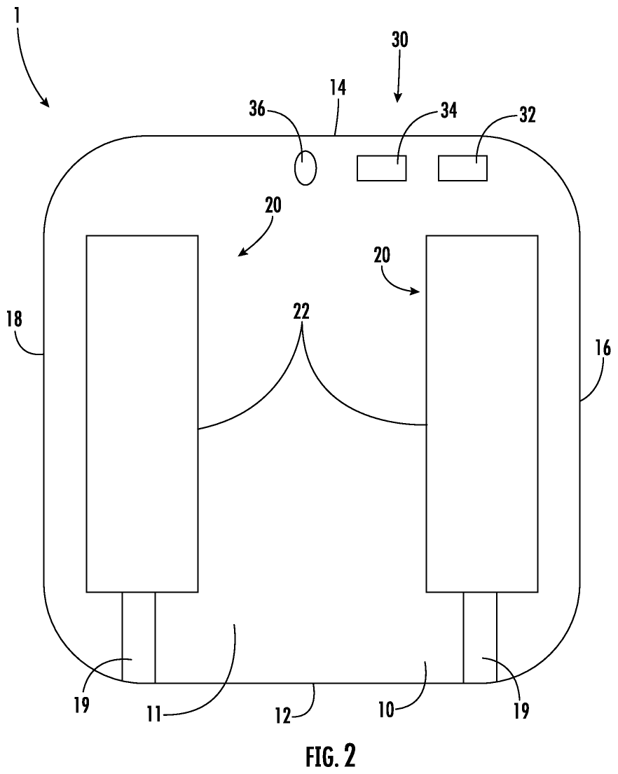

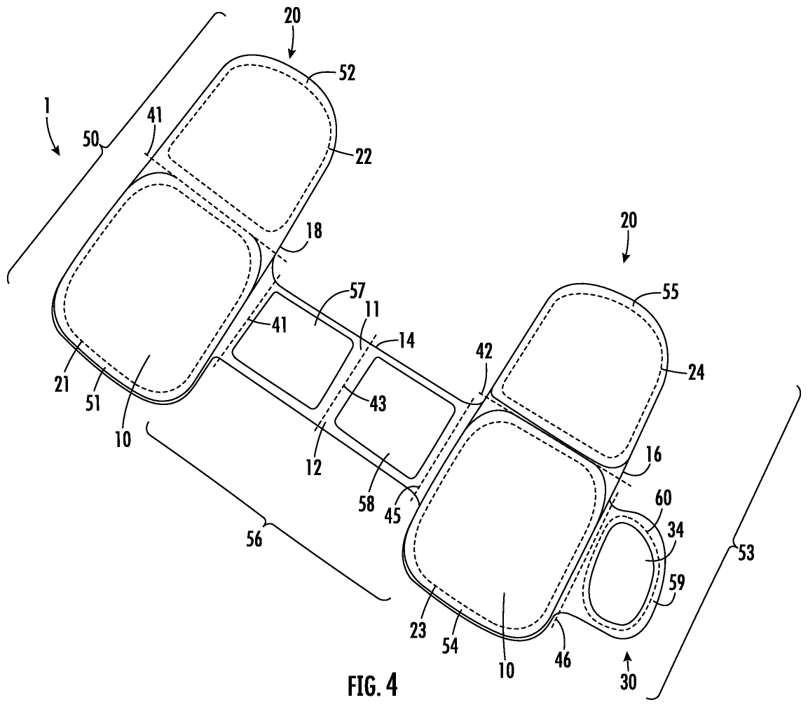

With reference to FIGS. 1-7, and as mentioned above, the electronic weight sensor assembly 1 comprises a pad 10. The pad 10 may be provided in various shapes and sizes according to intended geometrical configurations of the specific luggage unit(s) or other items that are intended to the weighed. The illustrative embodiments of FIGS. 1-2 show pads 10 comprising a substantially rectangular shape with round corners. The illustrative embodiments of FIGS. 1-2 are only exemplary not limiting of the shape of the pad 10 as other shapes and/or geometrical configurations may be provided. For example, other possible shapes of the pad are show in FIGS. 4-7. The top surface 11 of the pad 10 should comprise a sufficient dimension to accommodate at least one electronic weight sensor 21, 22, 23 and/or 24, which will be described later. As shown in the illustrative embodiments as represented in FIGS. 1-2, the top surface 11 comprises a sufficient dimension to accommodate the size of two electronic weight sensors, both indicated as 22 in these figures. In alternative embodiments, the top surface 11 may comprise a sufficient dimension to accommodate the size of more than two electronic weight sensors, e.g., 21, 22, 23 and/or 24 as shown in FIGS. 4-7. The pad 10 is generally provided with a first side edge 16 and a second side edge 18, as well as a front edge 12 and a back edge 14. Furthermore, the pad 10 should be lightweight, that is, the pad 10 should comprise a lesser density material. For example, the pad 10 may comprise synthetic polymer fabrics with a reduced density, and with a cover fabric on the top surface 11 and/or on an oppositely disposed bottom surface that may be placed on the floor. Further, the material of the pad 10 should allow for folding of the pad 10 in at least one direction such that the electronic weight sensor assembly 1 may be conveniently stored. For example, the electronic weight sensor assembly 1 may be folded into a collapsed or folded position, which will be explained later, such that it may be placed inside of a unit of luggage, pouch, case, bag, purse, etc. The electronic weight sensor assembly 1 may be folded and placed inside of a unit of luggage such that it may be used at various points in connection with a travel itinerary, as will be explained later. It is also within the scope of the present invention that other components, for example, the electronic weight sensors 21, 22, 23 and/or 24 may also be provided comprising a relatively low weight, such that the overall weight of the electronic weight sensor assembly 1 comprises an at least partially reduced weight.

The electronic weight sensor(s) 21, 22, 23 and/or 24 according to the present invention may comprise a variety of sensor technologies. As an illustrative example, the weight sensors may comprise a load cell, e.g., a force transducer, which is configured to convert compression or pressure into an electrical signal that may be measured and/or standardized. For example, as a force applied to the load cell increases, the electrical signal may change proportionally. Thereafter the electrical signal(s) may be processed and/or converted into a corresponding weight value. As a further example, a force sensing resistor (FSR) may be incorporated. A force sensing resistor (FSR) may comprise a material configured to change its resistance when a force, pressure, or mechanical stress is applied. The change in resistance may be converted into an electrical signal, e.g., via the processing unit 60. The size and/or shape of the electronic weight sensor(s) 21, 22, 23 and/or 24 may be dimensioned and configured according to the specific size of the pad 10.

As is shown in the illustrative embodiments of FIG. 4-7, the present invention comprises a processing unit 60. The processing unit 60 and/or processing board 60, may comprise a microprocessor, which may be cooperatively configured with sensors, i.e., 21, 22, 23 and/or 24, of the sensor assembly 20 to convert a pressure, force, stress, or change thereof, into an electrical signal representative of an associated weight. Furthermore, the processing unit 60 may also be operatively configured with the indicator assembly 30, e.g. with the display 34 to displace such weight as may be associated with the pressure, force, stress and/or change thereof. It is within the scope of the present invention that the processing unit 60 and/or components thereof comprise at least a minimum level of flexibility that allows for an integration into the pad 10 and/or sensors 21, 22, 23 and/or 24. It is also within the scope of the present invention that the processing unit 60 be configured with a programmable code or executable computer software for the purposes of integrating the sensors 21, 22, 23 and/or 24 and/or indicator assembly 30. The processing unit 60 may comprise an open-source hardware and/or software package that includes single-board microcontrollers and microcontroller kits. By way of example only, the processing unit 60 may comprise a processing board manufactured by Audino, LLC, and/or under the brand Audino®.

With reference again to FIGS. 1-2, and as mentioned above, electronic weight sensor assembly 1 comprises an indicator assembly 30. The indicator assembly 30 generally comprises a display 34, which is intended to show the weight of the specific luggage or other item that is intended to be weighed, which for simplicity are herein referred to as “unit of luggage” or “units of luggage”. The indicator assembly 30 may comprise a solar sensor 32. It is within the scope of the present invention that the weight sensor assembly 1 also comprise powering capabilities. Such powering capabilities are intended to provide the necessary electricity for the functioning of the various operative components of the electronic weight sensor assembly 1, including the electronic weight sensor(s) 22, the display 34, and/or attendant components that enable an operative communication between them. Thus, the electronic weight sensor assembly 1 may comprise one or more rechargeable battery units. For example, the battery units may be disposed on an inside of the pad 10.

As is shown in FIGS. 1-2, the indicator assembly 30 may comprise a solar sensor 32. A solar sensor 32 may be provided with photovoltaic components (e.g., a photovoltaic cell panel configured to capture solar energy and transform it into electricity). The solar sensor 32 may be configured to transform solar energy into electricity to replenish the charge of a battery unit(s). The electricity generated by the solar sensor 32 may also be transmitted directly to the operative components of the electronic weight sensor 1, e.g., electronic weight sensor(s) 22, the display 34, attendant components, etc.

With further reference to FIGS. 1-2, the indicator assembly 30 may further comprise a status indicator 36, as may be used in connection with the display 34. The status indicator 36 is primarily intended to indicate an “on” status or “off” status of the sensor assembly 20 and/or the indicator assembly 30. More precisely, the status indicator 36 may indicate an “on” status or an “off” status of the electronic weight sensors, i.e., 21, 22, 23 and/or 24, the displays 34 and/or the display 32. The status indicator 36 may be provided with a visual indicator, for example, LED lighting.

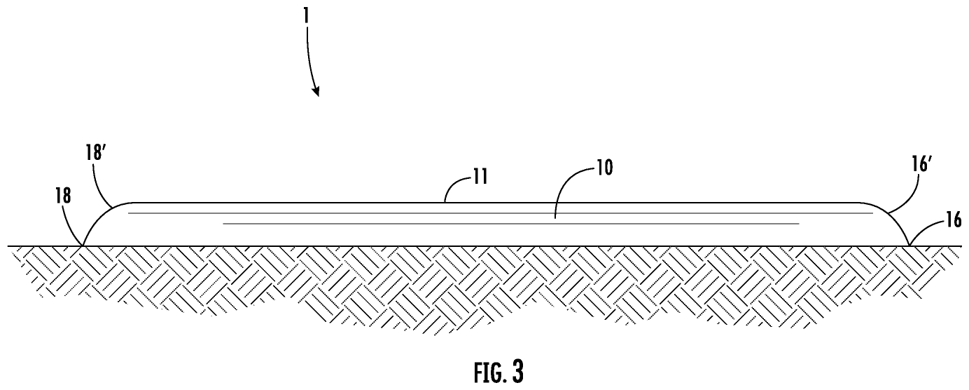

As is shown in FIG. 3, further features of the present invention comprise providing a tapered configuration of the pad 10 configured to at least partially facilitate displacement of a unit of luggage from a floor or other surface to the top surface 11 of the pad 10. As is shown in FIG. 3, a tapered configuration 18′ may be provided across the second side edge 18. The tapered configuration 18′ is intended to provide a smooth transition from a floor or other underlying surface to the pad 10. As an illustrative embodiment, the tapered configuration 18′ may comprise a slope of about 10 degrees to about 30 degrees from the horizontal plane. However, this range is not necessarily limiting as the tapered configuration 18′ may comprise other angles of inclination. In addition, the tapered configuration 18′ should transition from the approximate thickness of the pad 10 to a nearly imperceptible width near the second side edge 18. Other tapered configurations may also be provided at other edges of the pad 10. For example, a tapered configuration 16′ may be provided the first side edge 16. Furthermore, tapered configurations may also be provided at the front edge 12 and a back edge 14.

With particular reference to FIG. 2, the pad 10 according to the electronic weight sensor 1 of the present invention may comprise one or more tracks 19. The track(s) 19 may be configured to further provide access to the pad 10. The tracks 19 are primarily intended to function as a guide to the wheels of a unit of luggage. Accordingly, the tracks 19 may comprise an indentation or recessed configuration. Furthermore, the tracks 19 may also comprise a tapered configuration similar to that described above, e.g., 18′ and/or 16′. The tracks 19 may be disposed on the pad 10 along one or more edges thereof, e.g., 12, 14, 16 and/or 18. As shown in the illustrative embodiment of FIG. 2, the tracks 19 may be disposed on the pad 10 along a front edge 12. As shown in the illustrative embodiment of FIG. 2, each track 19 may be disposed in adjacent relation to a corresponding electronic weight sensor, e.g., 22. As is further shown in the illustrative embodiment of FIG. 2, each track 19 may also be disposed in adjacent relation to the front edge 12. As is also shown in the illustrative embodiment of FIG. 2, the tracks 19 may run in a direction parallel to the front edge 12 and the back edge 14. However, other configurations are possible and include the tracks 19 running in a direction from the first edge 16 to the second edge 18. Additionally, as is shown in FIG. 2, two tracks may be provided. Two tracks, however, are not strictly required as only one track 19 or more than two tracks 19 may also be provided. Additionally, the relative thickness of the tracks 19 may be adjusted according to the size of the pad 10 or to an intended size of the luggage unit(s).

Further features of the present invention comprise providing and/or implementing wireless capabilities to transmit weight data associated with one or readings of the innovative electronic weight sensor assembly 1. Wireless capabilities, including, but not limited to, Bluetooth®, Wi-Fi, LAN, Near-Field Communication (NFC) capabilities, may be used to transmit data associated with one or more weight readings. For example, weight data may be transmitted directly from the sensor assembly 20, i.e., via an electronic weight sensor, i.e., 21, 22, 23 and/or 24, to the indicator assembly 30, i.e., to the display 34.

Even additional features of the present invention comprise implementing a user platform cooperatively configured with the electronic weight sensor 1. The user platform may be accessed via a variety of devices, including mobile and/or desktop devices, and via a mobile application, and/or a web browser. The user platform may be accessed by one or more users via an application installed on a mobile device to allow users to check real-time data associated with one or more weight readings. Alternatively, and in addition to or in lieu of a standalone mobile application installed on a device, various features of the user platform may be conveniently accessed and/or stored on a device via a mobile wallet or through a web server(s) accessible via a mobile device. As such, weight data may be transmitted wirelessly from the sensor assembly 20 to the mobile or desktop device, for example via a server, data network, cloud computing, etc. The weight data may be similarly transmitted wirelessly from the indicator assembly 30 to a mobile or desktop device.

The user platform may also be provided with global positioning system (GPS) tracking capabilities, as may be required in connection with planning and/or implementing a travel itinerary. Such GPS tracking capabilities may comprise internal hardware components disposed on a luggage unit, a mobile device, of the electronic weight sensor assembly 1. For example, such internal components may comprise a receiver configured to obtain radio signals and ascertain a current location of a luggage unit, mobile device, etc. Such GPS tracking capabilities may also be used to ascertain a location of one or more units of luggage, for example, if they are misplaced, lost, sent to an incorrect location, etc. Further, such GPS tracking capabilities may be configured to ascertain data relating to a specific location(s) of one or more units of luggage or mobile devices, including various positions of travel in connection with a travel itinerary. Such GPS data may be displayed on the user platform such that a location of a unit of luggage or a mobile device may be determined at any given point.

The user platform may be accessed by one or more users to access weight data pursuant to one or more actual readings of the innovative electronic weight sensor assembly 1. Thus, it is within the scope of the present invention that the user platform be continuously updated in “real time”, which generally may involve updating with up-to-date or recent information relating with to an actual weight reading(s) of a unit of luggage using the innovative weight sensor assembly 1. It is also within the scope of the present invention that information relating to a weight reading(s) may be selectively transmitted and/or controlled by the user(s). That is, a user may take one or more readings on the weight sensor assembly 1 and access the user platform to automatically store and/or record such readings. Alternatively, a user may manually input actual weight readings or otherwise data relating to the weight of a unit(s) of luggage. The user platform may then process such acquired and/or inputted in connection with a specific travel itinerary, as will be explained hereinafter.

Even further features of the present invention comprise incorporating real-time aviation information to the user platform. Such aviation information may be included in a real-time database that may be accessed via the user platform. Aviation information may comprise commercial airline luggage restrictions, for example, number of allowed luggage units allowed on a given national or international flight, and its weight restrictions for on-board luggage and/or carry-on luggage. Restrictions in the number and weight of luggage may vary according to each specific commercial airline and/or the nature of the underlying flight, for example whether it is within a state, within a country, between more than one country, and/or the estimated travel time. Thus, the user platform may be accessed to compare whether the weight data associated with one or more weight readings comports to these travel requirements and/or guidelines from air carriers. If the weight data does not comport to specific travel requirements or guidelines, the user platform may indicate which specific units of luggage may need weight adjustments, and how much such adjustments may need to be. The user platform may also provide information with additional carrier fees associated with the current weight configuration of one or more units of luggage. Accordingly, it is within the scope of the present invention that the user platform be accessed to input specific travel information, e.g., airline, flight number, destination, city of origin, current flight, future flights, number of passengers, etc., and link this information with one or more units of luggage and/or corresponding weight readings. As such, the user platform may provide for an efficient way to confirm that one or more travel configurations, that is the weight information associated with one or more readings and/or associated units of luggage comport to the specific carrier requirements in connection with one or more travel itineraries. The user platform is also intended to be an easy to access resource to implement a weight reconfiguration scheme, i.e., to make weight adjustments to one or more units of luggage, as may become necessary to comport to such requirements and/or limit additional carrier fees associated with a specific travel itinerary.

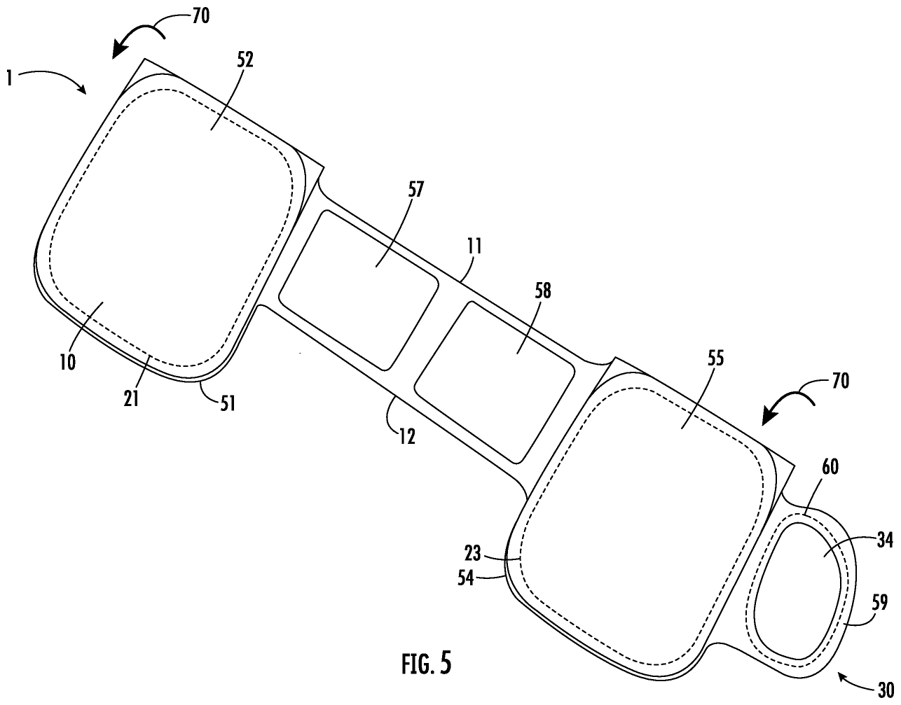

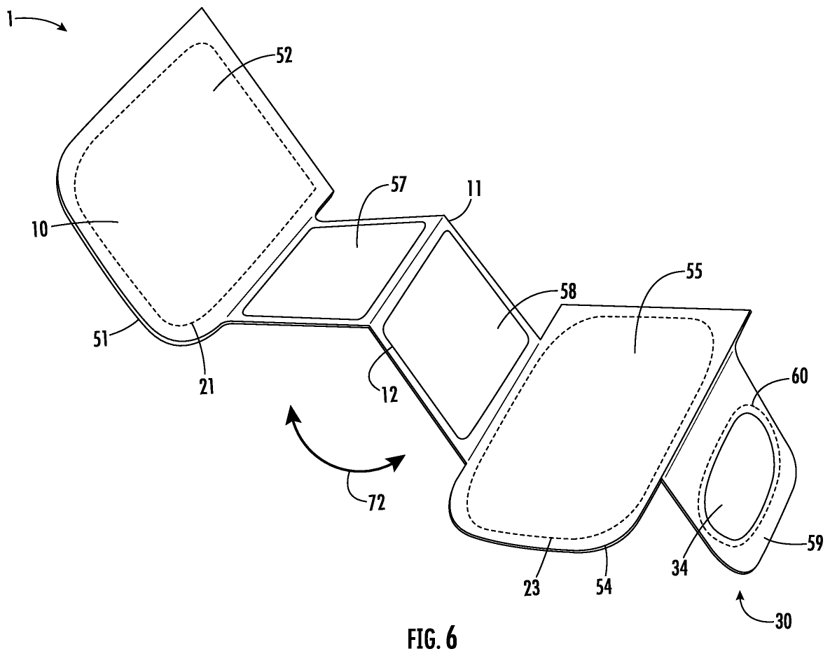

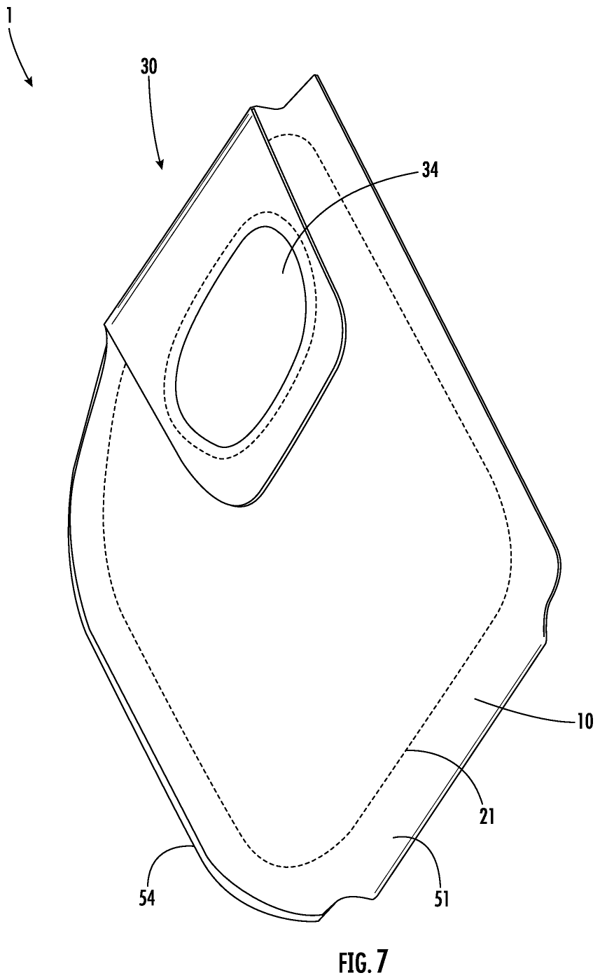

With reference now to FIGS. 4-7, additional features of the present invention further comprise the electronic weight sensor assembly 1 being disposable into and out of an expanded position and a folded position. It is within the scope of the present invention that the electronic weight sensor assembly 1 be disposable into an expanded position, i.e., FIG. 4, and that as such, it may be used to determine or ascertain the weight of an intended unit of luggage. The inventive electronic weight sensor assembly 1 may also be disposable into a collapsed position, i.e., FIG. 7, so that it may be conveniently stored, placed inside of a pouch or case, or placed inside of a bag or unit of luggage. As such, the electronic weight sensor assembly 1 may be provided with several groups of pad segments, shown in FIGS. 4 as 50, 53 and 56. The groups of pad segments 50, 53 and/or 56 may comprise one or two pad segments. For example, a first group of pad segments 50 may comprise a first left segment 51 and/or a second left segment 52. Also as an example, the second group of pad segments 53 may comprise a first right segment 54 and/or a second right segment 55. The second left segment 52 may be connected to and movable to the first left segment 51, for example, about a first fold line 41 of the pad. Similarly, the second right segment 55 may be connected to and movable to the first right segment 54, for example, about a second fold line 42. As such, and as is shown in FIGS. 5-6, the second right segment 52 may be disposed in confronting relation to the first right segment 51, and/or the second right segment 55 may be disposed in confronting relation to the second left segment 54. As such, the second left segment 52 and/or the second right segment 55 may be moved in the direction 70, which is shown in FIG. 5.

As is shown at least in FIGS. 4-6, a third group of pad segments 56 may be provided with at least one segment, and in some embodiments with a first central segment 57 and/or a second central segment 58. The first central segment 57 may be connected and movable to the second central segment about a third fold line 43 of the pad 10. As such, the first central segment 57 and the second central segment 58 may be moved in the direction 72 as shown in FIG. 6, such that they may ultimately be disposed in confronting relation to one another. The first group of pad segments 50, including the first left segment 51, may be adjacently disposed and movable to the third group of pad segments 56, including the first central segment 57, for example about a fourth fold line 44. Similarly, the second group of pad segments 53, including the first right segment 54 may be adjacently disposed and movable to the third group of pad segments 56, including the second central segment 58, for example about a fifth fold line 45. Additionally a display segment 59 may be provided to store the indicator assembly 30, including display 34, and/or other components such as the processing unit 60. It is also within the scope of the present invention that the display segment 59 be movable with respect to an adjacent group of segments, e.g., the second group of segments 53 and/or the first right segment 54, for example about a sixth fold line 46.

FIG. 7 shows an illustrative embodiment of the electronic weight sensor assembly disposed in the non-operative or collapsed position. The collapsed position primarily comprises at least the first left segment 51 disposed in confronting relation to one of the segments of the third group of pad segments 56. For example, in the collapsed position, the first left segment 51 may be disposed in confronting relation to the first central segment 57. Similarly, in the collapsed position, at least the first right segment 54 should be disposed in confronting relation to one of the segments of the third group of pad segments 56. For example, in the collapsed position, the first right segment 54 may be disposed in confronting relation to the second central segment 58. Furthermore, in the collapsed position the second left segment 52 and/or the second right segment 55 may be respectively disposed in confronting relation to the first left segment 51 and/or the first right segment 54. However, this is not strictly necessary, including in embodiments of the electronic weight sensor assembly 1 not comprising a second left segment 52 and/or a second right segment 55. Optionally, in the collapsed position, the display segment 59 may be disposed in confronting relation to one or more of the other segments 51, 52, 54 and/or 55. It is further contemplated that in order to achieve the collapsed position, that the pad 10 comprise a predetermined thickness that enables movement between adjacent segments, and further, an efficient and/or compact disposition of the electronic weight sensor assembly 10. Accordingly, the thickness of the pad 10 may be about two (2) millimeters to about four (4) millimeters. In at least one embodiments, the thickness of the pad 10 may be less than or equal to about four (4) millimeters. However, these thicknesses are not limiting as other thicknesses of the pad 10 and or specific segments may are also contemplated.

Also with reference to FIGS. 4-7, and as mentioned above the electronic weight sensor assembly 1 comprises a sensor assembly 20. The sensor assembly 20 may comprise a plurality of weight sensors, which may be disposed on a corresponding pad segment. It is within the scope of the present invention that a weight sensor, i.e., 21, 22, 23 and/or 24 be disposed on an inside of a corresponding pad segment, i.e., 51, 52, 54 and/or 55. Further, each weight sensor 21, 22, 23 and/or 24 should also be movable in the same direction of its corresponding pad segment, i.e., 51, 52, 54 and/or 55. Thus, when in the expanded position, i.e., FIG. 4, the sensors 21, 22, 23 and/or 24 should provide for different sections of contact with a specific unit of luggage, for example, at corners of the unit of luggage that correspond to the location of the wheels of the unit of luggage. Accordingly, each sensor 21, 22, 23 and/or 24 should be configured to ascertain at least a portion of the overall weight of the unit of luggage. It is within the scope of the present authority all of the sensors in combination ascertain substantially all of the weight of the specific unit of luggage. That is each sensor should be configured to ascertain a portion of the weight of the unit of luggage, and in combination all of the sensors should ascertain the overall weight of the unit of luggage, which may then be displayed on the display 34.

With reference now to FIG. 8, and as mentioned above, the present invention is also directed towards a method 100 of ensuring that the weight and number of a unit(s) of luggage associated with a given travel itinerary conform to specific requirements and guidelines of air carriers. Furthermore, embodiments of the method 100 further comprise incorporating the inventive electronic weight sensor assembly 1 to ensure conformance to requirements and guidelines of air carriers. Accordingly, the method 100 comprises logging into a user platform 110 as described herein. This may be accomplished via a mobile or desktop device, for example via a mobile application, web browser, or via a mobile wallet. The method 100 further comprises preforming a real-time update of aviation information 112 to the user platform. That is, a database accessible by, or otherwise associated with, the user platform, may be updated with specific requirements and/or guidelines of air carriers, for example, commercial airlines, airport regulations, etc. The method 100 may comprise a user inputting a flight itinerary 120, and performing a real-time update of specific requirements and/or guidelines based on the specific travel or flight itinerary 114. As used herein, inputting a flight itinerary 120 may comprise synching, creating, or otherwise enabling a flight itinerary or travel ticket to be accessible via the user platform, and/or also by airport staff, e.g., airline staff, TSA, security, etc. Furthermore, the method 100 may comprise performing a real-time update of the number and weight of permissible luggage units of a specific travel itinerary 116. The method 100 further comprises determining the weight of at least one luggage unit 130. For example, the method 100 may comprise providing and using the electronic weight sensor assembly 1 to determine the weight of at least one luggage unit 130.

Wireless capabilities, for example Bluetooth connectivity, may be used to transmit data relating with the weight of one or more luggage units, for example from the electronic weight sensor assembly 1 to the user platform. Data relating to the weight of one or more luggage units may also be transmitted, for example, to a server, data network, cloud computing, etc., of the air carrier. For example, data relating to the weight of a luggage unit(s) may be associated with a travel itinerary or an actual ticket, e.g., a ticket that may be printed or that be accessed through a mobile app, mobile wallet, web browser, etc. The method 100 further comprises comparing the weight data of one or more weighted luggage units to air carrier requirements and guidelines 140. For example, it is within the scope of the present invention that the air carrier staff and/or airport staff, have immediate access to the data relating to the weight of a luggage unit(s), as may be ascertained using the inventive electronic weight sensor assembly 1, for example, prior to arrival at the airport. This may at least partially reduce the amount of time associated with baggage check-in, and may also reduce the time and effort the staff will have otherwise needed to weight a unit(s) of luggage upon arrival at the airport. This may also at least partially reduce the staff's physical contact with the luggage unit(s) and may be used to expedite luggage check-in procedures, for example, via first class travel, pre-approved check-in, TSA, etc. For example, an curbside check-in kiosk, or an inside check-in kiosk, may have access to the weight of a unit(s) of luggage the moment a user uses the electronic weight sensor assembly 1 to ascertain the weight thereof. As an example, the user may access the user platform to record or otherwise save a weight reading of the electronic weight sensor assembly 1 of a unit of luggage(s), and that information may linked or associated with a ticket or travel itinerary in real-time.

If the actual weight and number of the smart luggage units is in conformance to the air carrier requirements and guidelines, the method 100 comprises providing a confirmation 150. If the actual weight and number of the smart luggage units is not in conformance to the air carrier requirements and guidelines, the method 100 may comprise implementing or providing a reconfiguration scheme 160. It is contemplated that with a reconfiguration scheme, that the user may adjust the weight and/or number of the luggage units such that their weight may be determined again by the weight sensor assembly 1 to verify and/or ensure conformance to the air carrier requirements and guidelines. For example, the reconfiguration scheme may comprise an alarm sent to the user via the user platform, i.e., on a mobile application or a mobile wallet, and it may also indicate which unit of luggage may not conform to the specific travel requirements and/or guidelines. This process may be repeated until the weight and/or number of the smart luggage assemblies are in conformance with the air carrier requirements.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. An electronic weight sensor assembly for ascertaining the weight of a unit of luggage, said electronic weight sensor assembly comprising:
a pad comprising a plurality of segments,
a sensor assembly comprising a plurality of sensors,
a processing unit disposed on an inside of said pad,
a display assembly operatively connected to said processing unit and at least partially disposed on said inside of said pad,
each one of said plurality of sensors disposed on an inside of said pad and operatively connected to said processing unit,
each one of said plurality of sensors configured to at least partially ascertain the weight of the unit of luggage, and
said pad disposable into and out of a folded position and an expanded position.

2. The electronic weight sensor assembly as recited in claim 1 wherein said sensor assembly comprises a first sensor and a second sensor; each one of said first sensor and said second sensor disposed on an inside of said pad and configured to at least partially ascertain the weight of the unit of luggage.

3. The electronic weight sensor assembly as recited in claim 2 wherein said sensor assembly further comprises a third sensor and a fourth sensor; each one of said third sensor and said fourth sensor disposed on an inside of said pad and configured to at least partially ascertain the weight of the unit of luggage.

4. The electronic weight sensor assembly as recited in claim 1 wherein said plurality of segments comprises a first group of segments, a second group of segments and a third group of segments; said third group of segments adjacently disposed to said first group of segments and said second group of segments.

5. The electronic weight sensor assembly as recited in claim 4 wherein said third plurality of segments comprises a first central segment and a second central segment; said first central segment connected to and movable with respect to said second central segment.

6. The electronic weight sensor assembly as recited in claim 4 wherein said first group of segments comprises a first left segment and a second left segment; said second plurality of segments comprising a first right segment and a second right segment.

7. The electronic weight sensor assembly as recited in claim 6 wherein said second left segment adjacently disposed and movable to said first segment.

8. The electronic weight sensor assembly as recited in claim 6 wherein said second right segment adjacently disposed and movable to said second segment.

9. The electronic weight sensor assembly as recited in claim 1 wherein said pad comprises a thickness that is less than or equal to 4 millimeters.

10. An electronic weight sensor assembly for ascertaining the weight of a unit of luggage, said electronic weight sensor assembly comprising:
a pad comprising a first group of segments, a second group of segments and a third group of segments; said third group of segments adjacently connected to said first group of segments and said second group of segments;
said first group of segments comprising a first left segment and a second left segment; said second left segment adjacently connected to and movable to said first left segment;
said second group of segments comprising a first right segment and a second right segment; said second right segment adjacently connected to and movable to said first right segment,
said third group of segments comprising a first central segment adjacently disposed and movable to a second central segment;
a sensor assembly comprising a first group of sensors and a second group of sensors; each one of said first group of sensors and said second group of sensors configured to at least partially ascertain the weight of the unit of luggage,
a processing unit disposed on an inside of said pad,
a display assembly operatively connected to said processing unit and at least partially disposed on said inside of said pad
each one of said first group of sensors and said second group of sensors operatively connected to said processing unit,
at least one of said first group of sensors is operatively disposed on an inside of a corresponding one of said first group of segments,
at least one of said second group of sensors is operatively disposed on an inside of a corresponding one said first group of segments, and
said pad disposable into and out of a folded position and an expanded position.

11. The electronic weight sensor assembly as recited in claim 10 wherein said first group of segments is adjacently disposed to and movable to said third group of segments;
said second group of segments is adjacently disposed to and movable to said third group of segments.

12. The electronic assembly as recited in claim 10 wherein said folded position comprises said second left segment is disposed in confronting relation to said first left segment and said second right segment is disposed in confronting relation to said first right segment.

13. The electronic assembly as recited in claim 12 wherein said folded position comprises said first central segment is disposed in confronting relation to said first right segment.

14. The electronic assembly as recited in claim 13 wherein said folded position comprises at least one of said first left segment or said second left segment disposed in confronting relation to said first central segment.

15. The electronic assembly as recited in claim 13 wherein said folded position comprises at least one of said first right segment or said second right segment disposed in confronting relation to said second central segment.

16. The electronic assembly as recited in claim 10 wherein a first sensor of said first group of sensors is disposed on an inside of said first left segment; a second sensor of said second group of sensors disposed on an inside of said first right segment.

17. The electronic assembly as recited in claim 16 wherein a third sensor of said first group of sensors is disposed on an inside of said second left segment; a fourth sensor of said second group of segments disposed on an inside of said second right segment.

18. A method of using an electronic weight sensor assembly for ascertaining the weight of at least one unit of luggage, the method comprising:
providing an electronic weight sensor assembly comprising:
a pad,
a sensor assembly comprising a plurality of sensors,
a processing unit disposed on an inside of the pad,
a display assembly operatively connected to the processing unit and at least
partially disposed on said inside of the pad,
each one of the plurality of sensors disposed on an inside of said pad and
operatively connected to the processing unit, and
each one of the plurality of sensors configured to at least partially ascertain
the weight of the at least one unit of luggage,
logging into user platform,
performing a real-time update of aviation information,
inputting a travel itinerary,
using the electronic weight sensor assembly to ascertain the weight of the at least one unit of luggage,
comparing the weight of the at least one unit of luggage to air carrier requirements, and
providing a confirmation to the user if the weight of the at least one unit of luggage conforms to the air carrier requirements.

19. The method as recited in claim 18 further comprising providing a reconfiguration scheme if the weight of the at least one unit of luggage does not conform to the air carrier requirements.

20. The method as recited in claim 18 further comprising performing a real-time update of luggage requirements based on a specific travel itinerary.
